(19) United States
(12) Patent Application Publication
(10) Pub. No.: US 2025/0279793 A1
(43) Pub. Date: Sep. 4, 2025

(54) WIRELESS COMMUNICATION ELECTRONIC DEVICE AND DRIVING METHOD USING THE SAME

(71) Applicants: Sernet (Suzhou) Technologies Corporation, Jiangsu (CN); Sercomm Corporation, Taipei City (TW)

(72) Inventor: Yuanhai Li, Jiangsu Province (CN)

(21) Appl. No.: 19/058,206

(22) Filed: Feb. 20, 2025

(30) Foreign Application Priority Data
Mar. 4, 2024 (CN) 202410241908.5

(51) Int. Cl. H04B 1/00; H04W 64/00; H04W 88/06

(52) U.S. Cl. CPC H04B 1/0053; H04W 64/006; H04W 88/06

(57) ABSTRACT

A wireless communication electronic device includes an antenna, a radio frequency unit, a power supply unit and a processor. The processor is configured to: when the wireless communication electronic device operates in a first operating frequency band, control the power supply unit to drive the radio frequency unit with a first driving voltage; and when the wireless communication electronic device operates in a second operating frequency band, control the power supply unit to drive the radio frequency unit with a second driving voltage. The second driving voltage is different from the first driving voltage. As a result, the wireless communication electronic device can drive the radio frequency unit with a suitable driving voltage in different working frequency bands, so that the expected communication quality can be obtained in each working frequency band and unnecessary power consumption can be avoided.

This application claims the benefit of People's Republic of China application Serial No. 202410241908.5, filed Mar. 4, 2024, the subject matter of which is incorporated herein by reference.

### TECHNICAL FIELD

The disclosure relates in general to an electronic device and a method using the same, and in particular, to a wireless communication electronic device and a driving method using the same.

### BACKGROUND

With the development of Wireless LAN (WLAN) technology, families, enterprises and other institutions increasingly rely on Wi-Fi and use it as the main means of accessing the network. In recent years, new applications have emerged that require higher throughput and latency, such as 4K and 8K video (the transmission rate may reach 20 Gbps), VR/AR, games (latency requirements are less than 5 microseconds (ms)), remote office, online video conferencing, cloud computing, etc. Wi-Fi coverage is often determined by the output power of the radio frequency (RF) unit. Since each country has special regulations on the EIRP (Equivalent Isotropic Radiated Power) of WI-FI, and Europe also has the ERP (Enterprise Resource Planning) energy-saving requirements, the output power of the RF unit cannot be increased indefinitely. Therefore, how to design a system that intelligently adjusts the performance of the RF unit has become one of the goals of the industry.

### SUMMARY

According to an embodiment, a wireless communication electronic device is provided. The wireless communication electronic device includes an antenna, a radio frequency unit, a power supply unit and a processor. The radio frequency unit is electrically connected to the antenna. The power supply unit is electrically connected to the radio frequency unit. The processor is electrically connected to the radio frequency unit and the power supply unit and configured to: when the wireless communication electronic device operates in a first operating frequency band, control the power supply unit to drive the radio frequency unit with a first driving voltage; and when the wireless communication electronic device operates in a second operating frequency band, control the power supply unit to drive the radio frequency unit with a second driving voltage. The second driving voltage is different from the first driving voltage.

According to another embodiment, a wireless communication electronic device is provided. The wireless communication electronic device includes a radio frequency unit, a power supply unit and a processor. The power supply unit is electrically connected to the radio frequency unit. The processor is electrically connected to the radio frequency unit and the power supply unit and configured to: in different operating frequency bands, control the power supply unit to drive the radio frequency unit with different driving voltages.

According to another embodiment, a driving method for a wireless communication electronic device includes the following steps: controlling a power supply unit to drive a radio frequency unit with a first driving voltage by a processor when a wireless communication electronic device operates in a first operating frequency band; and controlling the power supply unit to drive the radio frequency unit with a second driving voltage by the processor when the wireless communication electronic device operates in a second operating frequency band. The second driving voltage is different from the first driving voltage.

According to another embodiment, a wireless communication electronic device includes an antenna, a radio frequency unit, a power supply unit and a processor. The radio frequency unit is electrically connected to the antenna. The power supply unit is electrically connected to the radio frequency unit. The processor is electrically connected to the radio frequency unit and the power supply unit and configured to: when the wireless communication electronic device receives a first wireless signal power, control the power supply unit to drive the radio frequency unit with a first driving voltage; and when the wireless communication electronic device receives a second wireless signal power, control the power supply unit to drive the radio frequency unit with a second driving voltage. The second driving voltage is different from the first driving voltage.

According to another embodiment, a driving method for a wireless communication electronic device includes the following steps: when the wireless communication electronic device receives a first wireless signal power, controlling a power supply unit to drive a radio frequency unit with a first driving voltage by a processor; and when the wireless communication electronic device receives a second wireless signal power, controlling the power supply unit to drive the radio frequency unit with a second driving voltage by the processor. The second driving voltage is different from the first driving voltage.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### BRIEF DESCRIPTION OF THE DRAWINGS

FIG. 1 illustrates a functional block diagram of a wireless communication electronic device according to an embodiment of the present invention;

FIG. 2 illustrates a flow chart of a driving method of the wireless communication electronic device in FIG. 1; and

FIG. 3 illustrates a flow chart of a driving method of a wireless communication electronic device according to another embodiment of the present invention.

### DETAILED DESCRIPTION

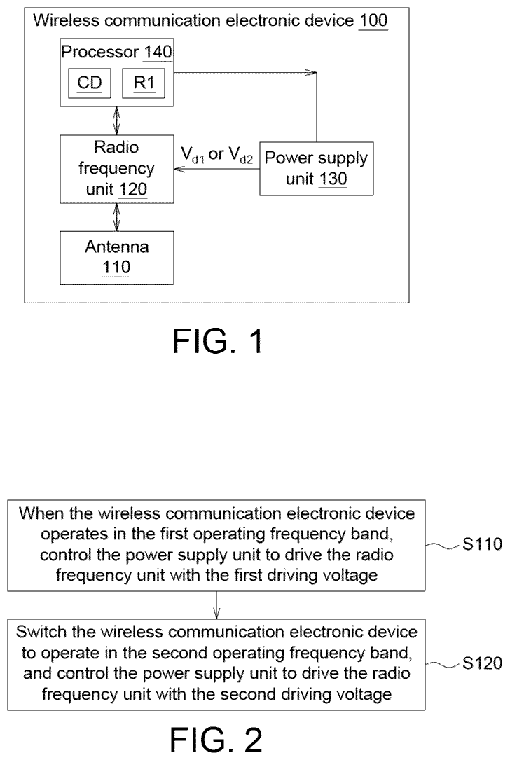

Referring to FIG. 1, FIG. 1 illustrates a functional block diagram of a wireless communication electronic device 100 according to an embodiment of the present invention. The wireless communication electronic device 100 is, for example, a router or an electronic device that may provide radio frequency.

As illustrated in FIG. 1, the wireless communication electronic device 100 includes an antenna 110, a radio frequency unit 120, a power supply unit 130 and a processor 140. The radio frequency unit 120, the power supply unit 130 and/or the processor 140 may be physical circuits, such as a semiconductor chip, a semiconductor package, which is formed by at least one semiconductor process. Furthermore, the power supply unit 130 is, for example, a high-efficiency voltage regulation module. The processor 140 is, for example, a system on a chip (SoC). The radio frequency unit 120 is, for example, a front-end module (FEM).

As illustrated in FIG. 1, the radio frequency unit 120 is electrically connected to the antenna 110. The power supply unit 130 is electrically connected to the radio frequency unit 120. The processor 130 is electrically connected to the radio frequency unit 120 and the power supply unit 130. The processor 130 is configured to: when the wireless communication electronic device 100 operates in a first operating frequency band, control the power supply unit 130 to drive the radio frequency unit 120 with a first driving voltage V_{d1}; and when the wireless communication electronic device 100 operates in a second operating frequency band, control the power supply unit 130 to drive the radio frequency unit 120 with a second driving voltage V_{d2}, wherein the second driving voltage V_{d2} is different from the first driving voltage V_{d1}. The wireless communication electronic device 100 according to the embodiment of the present invention may control the power supply unit 130 to drive the radio frequency unit 120 with different driving voltages according to different operating frequency bands. As a result, the radio frequency unit 120 may be driven with appropriate driving voltages under different operating frequency bands, thereby increasing wireless communication efficiency and reducing unnecessary power consumption (technical effects of energy saving and low radiation).

The driving voltage output to the radio frequency unit 120 affects the output power of the radio frequency unit 120. For example, drive voltage is proportional to output power. The allowed RF output powers are different for different operating frequency bands. As illustrated in Table 1 below, it lists the maximum output power (for example, effective isotropic radiated power) limits corresponding to different operating frequency bands in the Canadian regulations. For the operating frequency band of 5.15 GHz to 5.25 GHz, the maximum output power limit is 200 milliwatts (mW), while for higher frequency operating frequency bands, such as the operating frequency band of 5.725 GHz to 5.825 GHz, the maximum output power limit is allowed to be high to, for example, 1000 mW. Table 1 takes six groups of operating frequency bands and maximum output power as an example; however, it is not intended to limit the embodiment of the present invention. In another embodiment, there may be less than or more than six groups. Correspondingly, the number of driving voltage groups is not limited to two groups (the first driving voltage V_{d1} and the second driving voltage V_{d2}), but it may also be multiple groups.

TABLE 1

| operating frequency bands (GHz) | maximum output power limit (mW) |
|---|---|
| 5.15 to 5.25 | 200 |
| 5.25 to 5.35 | 250 |
| 5.47 to 5.725 | 250 |
| 5.65 to 5.73 | 250 |
| 5.725 to 5.825 | 1000 |
| 5.825 to 5.875 | 1000 |

In a case, when the wireless communication electronic device 100 operates in an operating frequency band required for the low radio frequency power, a low driving voltage is sufficient to drive the radio frequency unit 120 to obtain the expected communication quality. In the same operating frequency band requiring low radio frequency power, if the radio frequency unit 120 is driven with a high driving voltage will result in unnecessary power consumption. In another situation, when the wireless communication electronic device 100 operates in an operating frequency band required for the high radio frequency power, a high driving voltage is required to drive the radio frequency unit 120 to obtain the expected communication quality. In the same operating frequency band required for high RF power, a low driving voltage is insufficient to drive the RF unit 120 (the performance is not achieved).

Since the wireless communication electronic device 100 of the embodiment of the present disclosure may drive the radio frequency unit 120 with appropriate driving voltages under different operating frequency bands, expected communication quality may be obtained under each operating frequency band and unnecessary power consumption may be avoided. (technical effects of energy saving).

In addition, the processor 140 stores a corresponding relationship R1. In the present embodiment, the corresponding relationship R1 is, for example, the corresponding relationship between the operating frequency band and the driving voltage. The processor 140 is configured to: when the wireless communication electronic device 100 operates in the first operating frequency band, query the first driving voltage V_{d1} corresponding to the first operating frequency band according to the corresponding relationship R1; and when the wireless communication electronic device 100 operates in the second operating frequency band, query the second driving voltage V_{d2} corresponding to the second operating frequency band according to the corresponding relationship R1. The first operating frequency band may be one of the operating frequency bands listed in Table 1, and the second operating frequency band may be another one of the operating frequency bands listed in Table 1. In addition, the processor 140 may automatically detect a suitable operating frequency band in the area where it is located. For example, the processor 140 may select the one with the smallest noise from the operating frequency bands in the corresponding relationship R1 according to the signal from the antenna 110.

In addition, the aforementioned correspondence relationship R1 may be stored in the processor 140. The processor 140 further stores the country codes CD and multiple sets of corresponding relationships. One of the multiple sets of corresponding relationships (i.e., the corresponding relationship R1) corresponds to the country code CD. The multiple sets of correspondence relationships R1 respectively correspond to communication specifications of different countries. The processor 140 is further configured to: obtain the country code CD; and obtain the corresponding relationship R1 corresponding to the country code CD among the corresponding relationships. For example, if the country code CD represents Canada, the processor 140 obtains the corresponding relationship (for example, Table 1) corresponding to Canada, and determines the driving voltage corresponding to the operating frequency band based on the selected corresponding relationship. In another embodiment, the processor 140 may store only one set of corresponding relationship R1 corresponding to the country code CD, so that the corresponding relationship R1 may be directly used without obtaining the country code CD extra. In another embodiment, the processor 140 may negotiate the transmission power with the interconnected device and select the corresponding driving voltage according to the negotiated power. For example, as a slave device, when it detects that the received signal power is high (the distance is relatively close), the transmission power may be reduced, the radiation range may be reduced, and the driving voltage may be selected based on the transmission power.

Referring to FIG. 2, FIG. 2 illustrates a flow chart of a driving method of the wireless communication electronic device 100 in FIG. 1.

In step S110, when the wireless communication electronic device 100 operates in the first operating frequency band, the processor 140 controls the power supply unit 130 to drive the radio frequency unit 120 with the first driving voltage V_{d1}.

In step S120, the processor 140 switches the wireless communication electronic device 100 to operate in the second operating frequency band, and controls the power supply unit 130 to drive the radio frequency unit 120 with the second driving voltage V_{d2}, wherein the second driving voltage V_{d2} and the first The driving voltage V_{d1} is different.

Other steps of the driving method according to the embodiment of the present invention have been described above and will not be repeated again.

In another embodiment, the wireless communication electronic device 100 in FIG. 1 may also determine the driving voltage according to the wireless signal power. For example, the processor 140 is configured to: when the wireless communication electronic device 100 receives the first wireless signal power, control the power supply unit 130 to drive the radio frequency unit 120 with the first driving voltage; and when the wireless communication electronic device 100 receives the second wireless signal power, control the power supply unit 130 to drive the radio frequency unit 120 with the second driving voltage, wherein the second driving voltage and the first driving voltage is different.

In addition, the processor 140 stores the corresponding relationship R1 between the power and the driving voltage. In the present embodiment, the corresponding relationship R1 is, for example, the corresponding relationship between the power and the driving voltage. The processor 140 is configured to: when the wireless communication electronic device 100 receives the first wireless signal power (for example, the processor 140 obtains the corresponding wireless signal power according to (or by calculating) the wireless signal received by the antenna 110), according to the corresponding relationship R1, the processor 140 queries the first driving voltage V_{d1} corresponding to the first wireless signal power; and when the wireless communication electronic device 100 operates at the second wireless signal power, the processor 140 queries the second driving voltage V_{d2} corresponding to the second wireless signal power according to the corresponding relationship R1.

In addition, the aforementioned correspondence relationship R1 may be stored in the processor 140. The processor 140 further stores the country codes CD and multiple sets of corresponding relationships. One of the multiple sets of corresponding relationships corresponds to the country code CD. The multiple sets of correspondence relationships R1 respectively correspond to communication specifications of different countries. The processor 140 is further configured to: obtain the country code CD; and obtain the corresponding relationship R1 corresponding to the country code CD among the corresponding relationships. For example, if the country code CD represents Canada, the processor 140 obtains the corresponding relationship corresponding to Canada, and determines the driving voltage corresponding to the operating frequency band according to the selected corresponding relationship. In another embodiment, the processor 140 may store only one set of corresponding relationship R1 corresponding to the country code CD, so that the corresponding relationship R1 may be directly used without obtaining the country code CD extra.

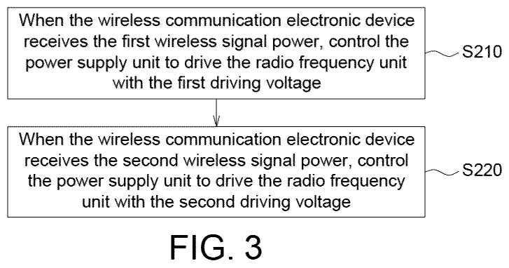

Referring to FIG. 3, FIG. 3 illustrates a flow chart of a driving method of a wireless communication electronic device according to another embodiment of the present invention.

In step S210, when the wireless communication electronic device 100 receives the first wireless signal power, the processor 140 controls the power supply unit 130 to drive the radio frequency unit 120 with the first driving voltage V_{d1}.

In step S220, the processor 140 controls the wireless communication electronic device 100 to switch to receive the second wireless signal power and controls the power supply unit 130 to drive the radio frequency unit 120 with the second driving voltage V_{d2}, wherein the second driving voltage V_{d2} and the first driving voltage V_{d1} is different.

Other steps of the driving method according to the embodiment of the present invention have been described above and will not be repeated again.

It will be apparent to those skilled in the art that various modifications and variations could be made to the disclosed embodiments. It is intended that the specifications and examples be considered as exemplary only, with the true scope of the disclosure being indicated by the following claims and their equivalents.

What is claimed is:

1. A wireless communication electronic device, comprising:
an antenna;
a radio frequency unit electrically connected to the antenna;
a power supply unit electrically connected to the radio frequency unit; and
a processor electrically connected to the radio frequency unit and the power supply unit and configured to:
when the wireless communication electronic device operates in a first operating frequency band, control the power supply unit to drive the radio frequency unit with a first driving voltage; and
when the wireless communication electronic device operates in a second operating frequency band, control the power supply unit to drive the radio frequency unit with a second driving voltage, wherein the second driving voltage is different from the first driving voltage.

2. The wireless communication electronic device according to claim 1, wherein the processor stores a corresponding relationship of an operating frequency band and driving voltage and is configured to:
when the wireless communication electronic device operates in the first operating frequency band, query the first driving voltage corresponding to the first operating frequency band according to the corresponding relationship; and
when the wireless communication electronic device operates in the second operating frequency band, query the second driving voltage corresponding to the second operating frequency band according to the corresponding relationship.

3. The wireless communication electronic device according to claim 1, wherein the processor is further configured to:
obtain a country code; and
obtain the corresponding relationship corresponding to the country code among a plurality of the corresponding relationships.

4. The wireless communication electronic device according to claim 1, wherein when the second operating frequency band is greater than the first operating frequency band, the second driving voltage is greater than the first driving voltage.

5. A wireless communication electronic device, comprising:
a radio frequency unit;
a power supply unit electrically connected to the radio frequency unit; and
a processor electrically connected to the radio frequency unit and the power supply unit and configured to:
in different operating frequency bands, control the power supply unit to drive the radio frequency unit with different driving voltages.

6. The wireless communication electronic device according to claim 5, wherein the processor stores a corresponding relationship of an operating frequency band and driving voltage and is configured to:
when in a first operating frequency band, query a first driving voltage corresponding to the first operating frequency band according to the corresponding relationship; and
when in a second operating frequency band, query a second driving voltage corresponding to the second operating frequency band according to the corresponding relationship.

7. The wireless communication electronic device according to claim 5, wherein the processor is further configured to:
obtain a country code; and
obtain the corresponding relationship corresponding to the country code among a plurality of the corresponding relationships.

8. A driving method for a wireless communication electronic device, comprising:
controlling a power supply unit to drive a radio frequency unit with a first driving voltage by a processor when a wireless communication electronic device operates in a first operating frequency band; and
controlling the power supply unit to drive the radio frequency unit with a second driving voltage by the processor when the wireless communication electronic device operates in a second operating frequency band;
wherein the second driving voltage is different from the first driving voltage.

9. The driving method according to claim 8, wherein the processor stores a corresponding relationship of an operating frequency band and driving voltage, and the driving method further comprises:
when the wireless communication electronic device operates in the first operating frequency band, querying the first driving voltage corresponding to the first operating frequency band according to the corresponding relationship; and
when the wireless communication electronic device operates in the second operating frequency band, querying the second driving voltage corresponding to the second operating frequency band according to the corresponding relationship.

10. The driving method according to claim 8, further comprises:
obtaining a country code; and
obtaining the corresponding relationship corresponding to the country code among a plurality of the corresponding relationships.

11. A wireless communication electronic device, comprising:
an antenna;
a radio frequency unit electrically connected to the antenna;
a power supply unit electrically connected to the radio frequency unit; and
a processor electrically connected to the radio frequency unit and the power supply unit and configured to:
when the wireless communication electronic device receives a first wireless signal power, control the power supply unit to drive the radio frequency unit with a first driving voltage; and
when the wireless communication electronic device receives a second wireless signal power, control the power supply unit to drive the radio frequency unit with a second driving voltage, wherein the second driving voltage is different from the first driving voltage.

12. The wireless communication electronic device according to claim 11, wherein the processor stores a corresponding relationship of a power and driving voltage and configured to:
query the first driving voltage corresponding to the first wireless signal power according to the corresponding relationship when the wireless communication electronic device operates at the first wireless signal power; and
query the second driving voltage corresponding to the second wireless signal power according to the corresponding relationship when the wireless communication electronic device operates at the second wireless signal power.

13. The wireless communication electronic device according to claim 11, wherein the processor is further configured to:
obtain a country code; and
obtain the corresponding relationship corresponding to the country code among a plurality of the corresponding relationships.

14. The wireless communication electronic device according to claim 11, wherein when the second wireless signal power is greater than the first wireless signal power, the second driving voltage is greater than the first driving voltage.

15. A driving method for a wireless communication electronic device, comprising:
when the wireless communication electronic device receives a first wireless signal power, controlling a power supply unit to drive a radio frequency unit with a first driving voltage by a processor; and
when the wireless communication electronic device receives a second wireless signal power, controlling the power supply unit to drive the radio frequency unit with a second driving voltage by the processor, wherein the second driving voltage is different from the first driving voltage.

16. The driving method according to claim 15, wherein the processor stores a corresponding relationship of a power and driving voltage, and the driving method further comprises:
when the wireless communication electronic device operates in the first wireless signal power, querying the first driving voltage corresponding to the first wireless signal power according to the corresponding relationship; and
when the wireless communication electronic device operates in the second wireless signal power, querying the second driving voltage corresponding to the second wireless signal power according to the corresponding relationship.

17. The driving method according to claim 15, further comprising:
obtaining a country code; and
obtaining the corresponding relationship corresponding to the country code among the plurality of the corresponding relationships.
